(19) United States
(12) Patent Application Publication
(10) Pub. No.: US 2025/0249779 A1
(43) Pub. Date: Aug. 7, 2025

(54) SYSTEMS AND METHODS FOR OPTIMIZING CHARGING AT AN ELECTRIC VEHICLE CHARGING STATION

(71) Applicant: Ford Global Technologies, LLC, Dearborn, MI (US)

(72) Inventors: Victor Martinez, Novi, MI (US); Brendan Diamond, Grosse Pointe, MI (US); Keith Weston, Canton, MI (US); Stuart C. Salter, White Lake, MI (US)

(73) Assignee: Ford Global Technologies, LLC, Dearborn, MI (US)

(21) Appl. No.: 18/435,119

(22) Filed: Feb. 7, 2024

(51) Int. Cl. B60L 53/66; B60L 53/62; B60L 53/67; H02J 7/00

(52) U.S. Cl. CPC B60L 53/66; B60L 53/62; B60L 53/67; H02J 7/00712

(57) ABSTRACT

A charging management system including a transceiver and a processor is disclosed. The transceiver may be configured to receive vehicle inputs associated with a plurality of vehicles located in a geographical area. The processor may be configured to estimate a probability of vehicle charging at a charging station located in the geographical area for each vehicle based on the vehicle inputs. The processor may further estimate a count of vehicles, from the plurality of vehicles, having respective probabilities of vehicle charging at the charging station greater than a predefined probability threshold. Further, the processor may cause the charging station to operate in a charge limit operational mode when the count of vehicles exceeds a predefined estimated count threshold. The charging station may be configured to limit an amount of charge transferred to a vehicle when the charging station operates in the charge limit operational mode.

### FIELD

The present disclosure relates to systems and methods for optimizing charging at an electric vehicle (EV) charging station by limiting an amount of charge transferred from the charging station to an EV.

### BACKGROUND

Electric Vehicles (EVs) require regular charging at EV charging stations to ensure optimal vehicle operation. It is known that an EV charges relatively quickly to a state of charge (SoC) level of 75% or 80%, and then the charging rate associated with the EV reduces. In most cases, the time duration required to charge an EV from a SoC level of 10 or 20% to 80% is considerably lower than the time duration required to charge the EV from 80% to 100%. Consequently, it may take a lot of time to charge an EV at a charging station if the EV charges close to 100% SoC. This may result in a long waiting time for other vehicles that may be waiting to get charged at the charging station, and formation of a long vehicle queue. Such instances may cause inconvenience to users or commuters at or in proximity to the charging station.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of a charging management system in accordance with the present disclosure.

FIG. 3 depicts an example snapshot of a heat map associated with a geographical area in accordance with the present disclosure.

FIG. 4 depicts an example view of a plurality of vehicles waiting at a charging station in accordance with the present disclosure.

FIG. 5 depicts a flow diagram of an example charging management method in accordance with the present disclosure.

### DETAILED DESCRIPTION

### Overview

The present disclosure describes a charging management system and method configured to optimize vehicle charging at one or more charging stations located in a geographical area. In some aspect, the charging management system (“system”) may optimize vehicle charging at a charging station by causing the charging station to limit an amount of charge that may be transferred to a charging vehicle and/or limit the vehicle charging time.

The system may be configured to obtain vehicle inputs associated with a plurality of vehicles that may be travelling in the geographical area. The vehicle inputs may include, for example, a state of charge (SoC) of each vehicle, information associated with historical vehicle charging events in the geographical area associated with each vehicle, and/or the like. Responsive to receiving the vehicle inputs, the system may estimate a probability of vehicle charging at the charging station for each vehicle based on the vehicle inputs, and estimate a count of vehicles having their respective probabilities greater than a predefined probability threshold. The system may further cause the charging station to operate in a charge limit operational model when the estimated count of vehicles may be greater than a predefined estimated count threshold. In some aspects, the charging station may be configured to limit an amount of charge transferred to a vehicle when the charging station operates in the charge limit operational mode. In additional or alternative aspects, the system may cause the charging station to operate in the charge limit operation model when a real-time count of vehicles waiting to be charged at the charging station exceeds a predefined real-time count threshold.

The limit on the amount of charge that the charging station may set may be based on a plurality of parameters including, but not limited to, the real-time count of vehicles waiting to be charged at the charging station, an expected waiting time at one or more chargers associated with the charging station, an expected future usage of the vehicle getting charged, and/or the like.

In some aspects, the charging station may apply the limit on the amount of charge that may be transferred to a vehicle when a vehicle operator associated with the vehicle accepts having such a charge limit applied to the vehicle at the charging station. The system/charging station may offer one or more incentives/discounts to the vehicle operator to encourage the vehicle operator to accept having the charge limit applied to the vehicle at the charging station.

The present disclosure discloses a charging management system and method configured to optimize vehicle charging at a charging station. The system may optimize vehicle charging at the charging station to maximize charging station energy throughput, and to minimize charge time per vehicle. The system further ensures that the vehicles get enough SoC/range at the charging station, so that the vehicles may conveniently reach their respective destination locations. These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

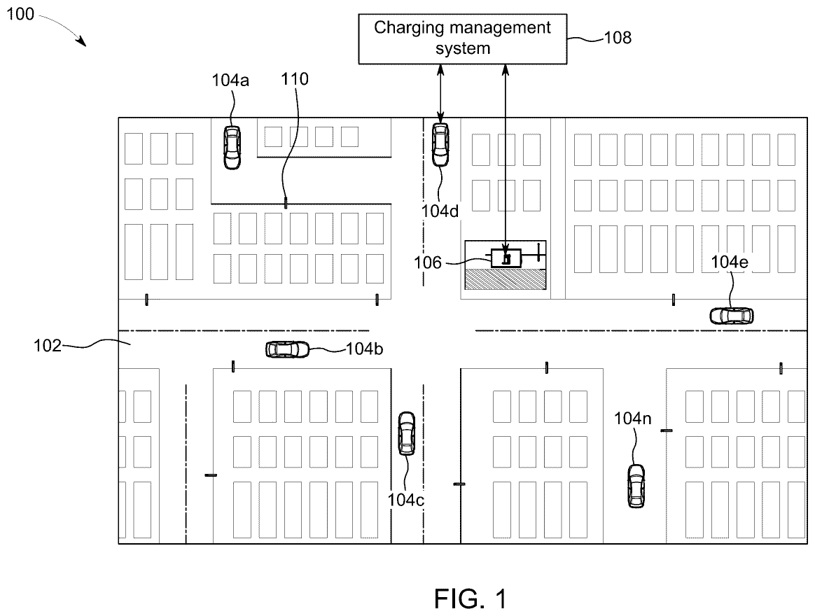

FIG. 1 depicts an example environment 100 in which techniques and structures for providing the systems and methods disclosed herein may be implemented. The environment 100 may include a geographical area 102 including a plurality of vehicles 104a, 104b, 104c, 104d, 104e, 104n (collectively referred to as vehicles 104) travelling on one or more road networks associated with the geographical area 102. The geographical area 102 may further include one or more Electric Vehicle (EV) charging stations (e.g., an EV charging station 106) where one or more vehicles from the plurality of vehicles 104 may get charged. Although FIG. 1 depicts a single EV charging station 106, the geographical area 102 may include more than one EV charging station. The example view depicted in FIG. 1 should not be construed as limiting.

Each vehicle 104 may take the form of any passenger or commercial vehicle such as a car, a work vehicle, a crossover vehicle, a truck, a van, a minivan, a taxi, a bus, etc. Further, each vehicle 104 may be a manually driven vehicle, and/or may be configured to operate in a fully autonomous (e.g., driverless) mode or a partially autonomous mode, and may include one or more electrically-actuated motor(s) or a hybrid system.

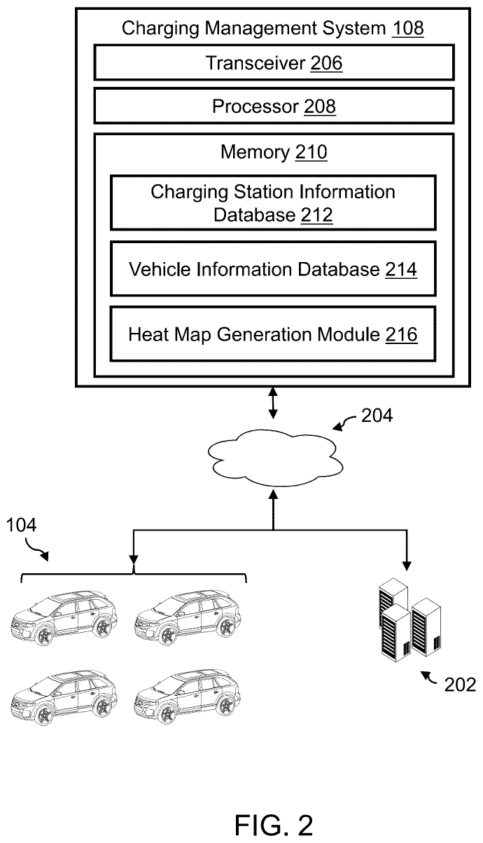

One or more vehicles 104 and the charging station 106 may be communicatively coupled with a charging management system 108 (or system 108) that may be configured to optimize vehicle charging at the charging station 106. Specifically, the system 108 may optimize vehicle charging at the charging station 106 such that a queue of vehicles waiting to get charged at the charging station 106 may not become long or may get formed at all, or waiting time at the charging station 106 may be considerably reduced. In some aspects, the system 108 may be hosted on a server. In other aspects, the system 108 may be part of a computing device associated with the charging station 106 (and a plurality of other charging stations located in the geographical area 102). Further, the system 108 may be communicatively coupled with the vehicles 104 via vehicle-to-vehicle communication (V2V) communication, vehicle-to-infrastructure (V2I) communication, and/or via a network (shown as network 204 in FIG. 2).

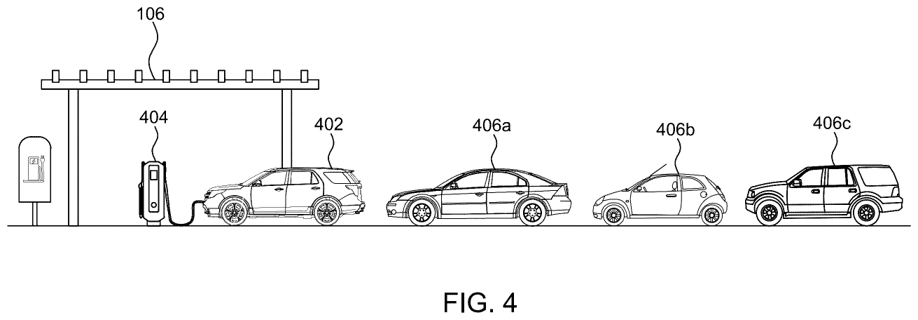

In some aspects, the system 108 may optimize vehicle charging at the charging station 106 by limiting an amount of charge that may be transferred to a vehicle getting charged at a charger (shown as charger 404 in FIG. 4) in the charging station 106 and/or a charging time for which the vehicle may get charged at the charger. A person ordinarily skilled in the art may appreciate that by liming the amount of charge transferred to the vehicle and/or the vehicle charging time, the system 108 may ensure that the vehicle does not stay at the charging station 106 for a long time duration, thereby ensuring that waiting times for other vehicles at the charging station 106 may be reduced and long vehicle queues may not be formed at the charging station 106. The process implemented by the system 108 for optimizing vehicle charging at the charging station 106 is briefly described below, and described in detail later in the description in conjunction with FIG. 2.

The system 108 may first obtain vehicle inputs associated with the plurality of vehicles 104 from one or more infrastructure sensors (e.g., an infrastructure sensor 110), one or more sensors (not shown) associated with the charging station 106, directly from the vehicles 104, and/or from one or more external servers (shown as server 202 in FIG. 2). In some aspects, the vehicle inputs may include images of the vehicles 104 in the geographical area 102 captured by cameras, radio detection and ranging (radar) sensors, light detection and ranging (lidar) sensors, etc. associated with the vehicles 104, the infrastructure sensors and/or the sensors associated with the charging station 106. In additional aspects, the vehicle inputs may include state of charge (SoC) level associated with each vehicle 104, information associated with historical vehicle charging events in the geographical area 102 associated with each vehicle 104, and/or the like, which the system 108 may obtain from the vehicles 104 and/or the external server. In some aspects, the information associated with the historical vehicle charging events in the geographical area 102 associated with each vehicle 104 may include, for example, information indicating when (e.g., days of week, time of day, etc.) each vehicle 104 typically gets charged at the charging station 106 (and/or other charging stations located in the geographical area 102), locations of charging stations in the geographical area 102 where each vehicle 104 typically gets charged, typical SoC level at which each vehicle 104 gets charged in the geographical area 102, and/or the like. In further aspects, the vehicle inputs may include known regular schedules from fleet vehicles that may be travelling in the geographical area 102, including, but not limited to, schedules from a fleet vehicle server.

Responsive to receiving the vehicle inputs described above, the system 108 may determine a total count of vehicles 104 in the geographical area 102, a SoC level of each vehicle 104, and vehicle charging habits/patterns associated with each vehicle 104 in the geographical area 102, based on the vehicle inputs. The system 108 may further estimate a probability of each vehicle 104 getting charged at the charging station 106 (and/or other charging stations located at the geographical area 102) based on the vehicle inputs. Specifically, the system 108 may estimate the probability of each vehicle 104 getting charged at the charging station 106 based on the SoC level of each vehicle 104 in the geographical area 102 and/or the vehicle charging habits/patterns associated with each vehicle 104 in the geographical area 102. Responsive to estimating the probability of each vehicle 104 getting charged at the charging station 106, the system 108 may estimate a count of vehicles, from the total count of vehicles 104, having their respective probabilities of vehicle charging at the charging station 106 greater than a predefined probability threshold (e.g., 75% or 80%).

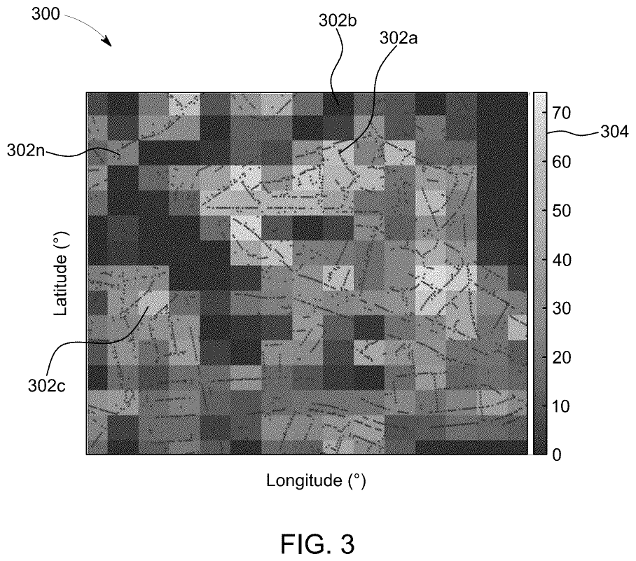

In some aspects, the system 108 may estimate the count of vehicles described above by generating a heat map (shown as heat map 300 in FIG. 3) associated with the geographical area 102, and regularly updating the heat map as new data may be obtained by the system 108. The heat map associated with the geographical area 102 may indicate or include information associated a total count of vehicles that are typically located in each sub-area or sub-region of the geographical area 102 at different times of the day, different days of the week, etc., typical SoC levels of the vehicles in each sub-area or sub-region, typical charging patterns of the vehicles in each sub-area or sub-region, and/or the like. The system 108 may build or generate the heat map described above by using the vehicle inputs obtained by the system 108 over a predefined time duration (e.g., 1 month, 3 months, 6 months, 12 months, etc.). The system 108 may further update the heat map over time, to regularly refine the heat map and make the information included in the heat map more accurate. In some aspects, the system 108 may use the heat map to estimate the count of vehicles that may have their respective probabilities to charge at the charging station 106 greater than the predefined probability threshold.

Responsive to estimating the count of vehicles based on the vehicle inputs and/or the heat map as described above, the system 108 may compare the count of vehicles with a predefined estimated count threshold. The system 108 may cause the charging station 106 to operate in a charge limit operational mode when the system 108 determines that the count of vehicles may be greater than the predefined estimated count threshold. Stated another way, the system 108 may cause the charging station 106 to operate in the charge limit operational mode when the system 108 estimates that a large count of vehicles may visit the charging station 106 to get charged, or a count of vehicles having propensity to charge at the charging station 106 may be high.

Although the description above describes as aspect where the system 108 causes the charging station 106 to operate in the charge limit operational mode when the system 108 “estimates” that a large count of vehicles may visit the charging station 106 to get charged, the present disclosure is not limited to such as aspect. In further aspects, the system 108 may cause the charging station 106 to operate in the charge limit operational mode when a real-time count of vehicles waiting to be charged at the charging station 106 may be greater than a predefined real-time count threshold. In this case, the system 108 may obtain real-time charging station inputs associated with the charging station 106 from one or more sensors located at the charging station 106, computing devices/systems associated with the charging station 106, and/or the external server, and may determine the real-time count of vehicles waiting to be charged at the charging station 106 based on the real-time charging station inputs.

In some aspects, the charging station 106 may be configured to put a limit to an amount of charge that may be transferred to a vehicle getting charged at the charging station 106, when the charging station 106 may be operating in the charge limit operational mode. For example, if the vehicle 104a may be getting charged at the charging station 106 when the charging station 106 may be operating in the charge limit operational mode, the charging station 106 may put a limit to an amount of charge that may be transferred to the vehicle 104a such that the vehicle 104a may get charged to an SoC level of 80% or 85% (and not fully to 100% SoC level) or till a pre-calculated range. In some aspects, the charging station 106 may put a limit to an amount of charge that may be transferred to the vehicle 104a when the vehicle 104a (specifically a vehicle operator associated with the vehicle 104a) agrees to accepting such a charging limit/constraint. In an exemplary aspect, the vehicle operator may accept the charging limit/constraint in lieu of discounts on the charging price and/or other incentives that may be offered by the system 108/charging station 106 to the vehicle operator.

The system 108 may set and/or control the amount of charge that may be transferred to the vehicle 104a at the charging station 106 based on a plurality of parameters. For example, the system 108 may set and/or control the amount of charge based on the real-time count of vehicles waiting to be charged at the charging station 106, an expected waiting time at one or more chargers located at the charging station 106, a current SoC level of the vehicle 104a, information associated with an expected future vehicle usage for the vehicle 104a, a destination location associated with a vehicle route of the vehicle 104a, a distance between the charging station 106 and another charging station on the vehicle route, and/or the like. The system 108 may further set and/or control a vehicle charging time for the vehicle 104a at the charging station 106 based on the amount of charge and a charging rate capability associated with a charger that may be charging the vehicle 104a. For example, the system 108 may increase the vehicle charging time when the charger may be a regular charger, and may decrease the vehicle charging time when the charger may be a fast charger (for the same amount of charge to be transferred to the vehicle 104a).

The system 108 may be further configured to transmit/broadcast a location associated with the charging station 106 (and other charging stations located in the geographical area 102), an expected waiting time at the charging station 106, a real-time count of vehicles waiting to be charged at the charging station 106, information associated with a charging price at the charging station 106, and/or the like, to the plurality of vehicles 104 so that the respective vehicle operators may plan charging for their vehicles. As an example, the vehicle operators may not visit the charging station 106 if the waiting time at the charging station 106 may be high. This may further facilitate in optimizing vehicle charging at the charging station 106.

Further system details are described below in conjunction with FIG. 2.

The vehicles 104 and the system 108 implement and/or perform operations, as described here in the present disclosure, in accordance with the owner manual and safety guidelines. In addition, any action taken by the operators associated with the vehicles 104 based on the notifications/recommendations provided by the system 108 should comply with all the rules specific to the location and operation of the vehicles 104 (e.g., Federal, state, country, city, etc.). The notifications/recommendations, as provided by the system 108, should be treated as suggestions and only followed according to any rules specific to the location and operation of the vehicles 104.

FIG. 2 depicts a block diagram of the charging management system 108 in accordance with the present disclosure. While describing FIG. 2, references will be made to FIGS. 3 and 4. As described above, in some aspects, the system 108 may be hosted on a server. In other aspects, the system 108 may be part of a computing device associated with the charging station 106 (and a plurality of other charging stations located in the geographical area 102).

The system 108 may be communicatively coupled with the plurality of vehicles 104 located at the geographical area 102, one or more servers 202 (or a server 202), infrastructure sensors (e.g., the infrastructure sensor 110) located at the geographical area 102, and computing devices associated with the plurality of charging stations located at the geographical area 102, via V2V communication, V2I communication, and/or one or more networks 204 (or a network 204).

The server 202 may be part of a cloud-based computing infrastructure and may be associated with and/or include a Telematics Service Delivery Network (SDN) that provides digital data services to the vehicles 104 and/or the system 108. In further aspects, the server 202 may be configured to store and provide one or more vehicle inputs to the system 108. For example, the server 202 may store and provide information associated with historical vehicle charging events in the geographical area 102 associated with each vehicle 104, information associated with an expected future vehicle usage for a predefined future time duration for each vehicle 104, a destination location associated with a vehicle route of each vehicle 104, and/or the like, to the system 108 at a predefined frequency, or when the system 108 transmits a request to the server 202 to obtain such information. In additional aspects, the server 202 may be configured to store and provide charging station information associated with the plurality of charging stations (including the charging station 106) that may be located in the geographical area 102 to the system 108. The charging station information may include, for example, locations of the plurality of charging stations, charging price at each charging station, information associated with availability or non-availability of fast chargers at each charging station, charge rate capability/capacity of each charger at each charging station, and/or the like.

The network 204 illustrates an example communication infrastructure in which the connected devices discussed in various embodiments of this disclosure may communicate. The network 204 may be and/or include the Internet, a private network, public network or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The system 108 may include a plurality of units including, but not limited to, a transceiver 206, a processor 208 and a memory 210. The transceiver 206 may be configured to transmit/receive information/data to/from external systems and devices via the network 204. For example, the transceiver 206 may be configured to receive/transmit inputs/information/data from/to the vehicles 104, the server 202, infrastructure sensors (e.g., the infrastructure sensor 110) located at the geographical area 102, and/or the like.

The processor 208 may be in communication with one or more memory devices in communication with the respective computing systems (e.g., the memory 210 and/or one or more external databases not shown in FIG. 2). The processor 208 may utilize the memory 210 to store programs in code and/or to store data for performing aspects in accordance with the disclosure. The memory 210 may be a non-transitory computer-readable storage medium or memory storing a program code that enables the processor 208 to perform operations in accordance with the present disclosure. The memory 210 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 210 may include a plurality of databases/modules including, but not limited to, a charging station information database 212, a vehicle information database 214, a heat map generation module 216, and/or the like. The charging station information database 212 may store the charging station information that the system 108 may obtain from the server 202, one or more sensors located at the charging stations (e.g., the charging station 106) in the geographical area 102, and/or the computing devices associated with the charging stations. The vehicle information database 214 may store the vehicle inputs associated with the vehicles 104 that the system 108 may obtain from the vehicles 104, the server 202, and/or the infrastructure sensors located in the geographical area 102. The heat map generation module 216 may include and/or store computer executable instructions that may enable the processor 208 to perform one or more operations in accordance with the present disclosure. The function of the heat map generation module 216 may be understood in conjunction with the description provided below.

In operation, the transceiver 206 may receive the vehicle inputs associated with the plurality of vehicles 104 that may be located in the geographical area 102. In some aspects, the transceiver 206 may receive the vehicle inputs directly from the vehicles 104, and/or from the infrastructure sensors located in the geographical area 102, the server 202, etc. Examples of the vehicle inputs are already described above in conjunction with FIG. 1.

Responsive to receiving the vehicle inputs, the transceiver 206 may transmit the vehicle inputs to the processor 208 and/or to the vehicle information database 214 for storage purpose. In some aspects, the transceiver 206 may receive the vehicle inputs for a predefined time duration (e.g., 1 month, 3 months, 6 months, or more) and transmit the vehicle inputs to the vehicle information database 214, so that a “database of vehicle inputs” may be formed in the memory 210. Such database may include information associated with a total count of vehicles that typically travel in the geographical area 102 (and its sub-areas/sub-regions) during different times of the day, different days of the week, etc., typical SoC levels of the vehicles that travel through the geographical area 102, charging habits/patterns of the vehicles that travel through the geographical area 102, and/or the like. The processor 208 may execute the instructions stored in the heat map generation module 216 to generate and update a heat map (e.g., a heat map 300 shown in FIG. 3) that may enable the processor 208 to estimate a count of vehicles that may charge at the charging station 106. The concept of the heat map 300 is described later in the description below.

In addition to receiving the vehicle inputs, the transceiver 206 may receive the charging station information from the server 202 and/or the computing devices associated with the plurality of chargers located in the geographical area 102. Examples of the charging station information is already described above. The transceiver 206 may further receive real-time station inputs associated with the plurality of charging stations (including the charging station 106) from the infrastructure sensors, the vehicles 104 and/or the computing devices associated with the plurality of chargers located in the geographical area 102. The real-time station inputs may include, e.g., images of the charging stations, a real-time count of vehicles waiting to be charged at each charging station (including the charging station 106), and/or the like. The transceiver 206 may transmit the received charging station information and/or the real-time station inputs to the processor 208 and/or the charging station information database 212 for storage purpose.

The processor 208 may obtain the vehicle inputs directly from the transceiver 206 or from the vehicle information database 214 (e.g., for the predefined time duration described above), and may estimate a probability of vehicle charging at the charging station 106 (and other charging stations located in the geographical area 102) for each vehicle 104 based on the vehicle inputs. As an example, the processor 208 may estimate a probability of vehicle charging at the charging station 106 for each vehicle 104 based on an SoC level of each vehicle 104 while travelling in the geographical area 102 and/or the information associated with charging habits/pattern of each vehicle 104 at the charging station 106 or in the geographical area 102.

Responsive to estimating the probabilities, the processor 208 may compare the estimated probability of each vehicle 104 with a predefined probability threshold, and estimate a count of vehicles (from the plurality of vehicles 104) having respective probabilities of vehicle charging at the charging station 106 (and other charging stations located in the geographical area 102) greater than the predefined probability threshold. Stated another way, the processor 208 may estimate a count of vehicles in the geographical area 102 that may have a high probability of charging at the charging station 106 or a propensity to charge at the charging station 106.

In some aspects, the processor 208 may estimate the count of vehicles described above by using the heat map 300 associated with the geographical area 102. The processor 208 may generate the heat map 300 by executing the instructions stored in the heat map generation module 216 and using the vehicle inputs obtained by the processor 208 over the predefined time duration. In an exemplary aspect, the geographical area 102 may include a plurality of sub-regions/sub-areas 302a, 302b, 302c, 302n (collectively referred to as sub-areas 302), and the heat map 300 may indicate a typical count of vehicles in each sub-area 302 on a given time and a given day of the week. For example, as shown in FIG. 3, the sub-area 302a may have more vehicles travelling through it, as compared to the sub-area 302b. An example legend for the heat map 300 is shown as legend 304 in FIG. 3. Further, X-axis of the heat map 300 may denote longitude for a specific sub-area, and Y-axis of the heat map 300 may denote latitude for the sub-area.

The processor 208 may generate the heat map 300, and continuously update/refine the heat map 300 as more vehicle inputs may be obtained by the processor 208 over time (e.g., when the vehicles 104 travel on repeated trips in the geographical area 102 over time). The processor 208 may store the generated heat map 300 in the memory 210, and fetch the heat map 300 from the memory 210 when the processor 208 may be required to estimate the count of vehicles having respective probabilities of vehicle charging at the charging station 106 greater than the predefined probability threshold. In some aspects, the information included/stored in the heat map 300 may further include typical SoC levels of the vehicles in each sub-area 302, their propensity to charge in charging stations located in the sub-areas 302, charging habits/patterns associated with each vehicle 104 in each sub-area 302, and/or the like. Such information included in the heat map 300 may facilitate the processor 208 to efficiently estimate, at any given time, the count of vehicles having respective probabilities of vehicle charging at the charging station 106 (and other charging stations located in the sub-areas 302) greater than the predefined probability threshold.

Responsive to estimating the count of vehicles as described above, the processor 208 may compare the estimated count of vehicles with a predefined estimated count threshold. The processor 208 may transmit a command signal to the charging station 106 (e.g., to the computing device/system associated with the charging station 106) and cause the charging station 106 to operate in the charge limit operational mode when the estimated count of vehicles exceeds the predefined estimated count threshold. As described above in conjunction with FIG. 1, the charging station 106 may be configured to limit an amount of charge transferred to a vehicle (e.g., the vehicle 104a) and/or a vehicle charging time when the charging station 106 operates in the charge limit operational mode.

Although the description above describes as aspect where the processor 208 causes the charging station 106 to operate in the charge limit operational mode when the “estimated” count of vehicles exceeds the predefined estimated count threshold, the present disclosure is not limited to such as aspect. In alternative or additional aspects, the processor 208 may cause the charging station 106 to operate in the charge limit operational mode when a real-time count of vehicles waiting to be charged at the charging station 106 exceeds a predefined real-time count threshold. In this case, the processor 208 may obtain the real-time station inputs associated with the charging station 106 from the transceiver 206 or the charging station information database 212, and may determine the real-time count of vehicles waiting to be charged at the charging station 106 based on the real-time station inputs. Responsive to determining the real-time count of vehicles, the processor 208 may cause the charging station 106 to operate in the charge limit operational mode when the real-time count of vehicles exceeds the predefined real-time count threshold.

As described above, the charging station 106 may be configured to limit an amount of charge transferred to a vehicle that may be getting charged, when the charging station 106 operates in the charge limit operational mode. In some aspects, the amount of charge that may be transferred to the vehicle may be based on the real-time count of vehicles waiting to be charged at the charging station 106. For example, the charging station 106 may allow a vehicle to get charged up to an SoC level of 90% when the real-time count of vehicles waiting to be charged at the charging station 106 may be low (e.g., two or three vehicles), and may allow a vehicle to get charged up to a maximum of 70% SoC level when the real-time count of vehicles waiting to be charged at the charging station 106 may be high (e.g., more than seven or eight vehicles).

In further aspects, the transceiver 206 may be configured to receive real-time vehicle inputs associated with one or more vehicles getting charged at one or more chargers associated with the charging station 106. An example view of a vehicle 402 getting charged at a charger 404 associated with the charging station 106 is depicted in FIG. 4. FIG. 4 also depicts one or more vehicles 406a, 406b, 406c waiting to get charged by using the charger 404 at the charging station 106.

In the exemplary aspect depicted in FIG. 4, the transceiver 206 may receive real-time vehicle inputs associated with the vehicle 402, from the vehicle 402 via V2V communication, V2I communication and/or the network 204. The transceiver 206 may transmit the real-time vehicle inputs associated with the vehicle 402 to the processor 208, and the processor 208 may determine an expected charge rate (e.g., an expected rate at which the electric charge may be getting transferred to the vehicle 402), an expected charge completion SoC level, and/or a current SoC level associated with the vehicle 402 based on the real-time vehicle inputs. For example, the processor 208 may determine that the current SoC level associated with the vehicle 402 may be 30% and the expected charge completion SoC level may be 75%. In some aspects, the processor 208 may determine the expected charge completion SoC level associated with the vehicle 402 based on historical vehicle charging pattern associated with the vehicle 402, a limit set by the charging station 106 on the amount of charge that may be transferred to the vehicle 402 at the charging station 106, and/or the like.

The processor 208 may similarly determine the information described above for the vehicles 406a, 406b and 406c. The processor 208 may then estimate an expected waiting time at the charger 404 based on the determined expected charge rate, the expected charge completion SoC level, and the current SoC level associated with the vehicles 402, 406a, 406b and 406c.

In some aspects, the processor 208 may cause the charging station 106 to set the limit on the amount of charge that may be transferred to a new vehicle entering the charging station 106 (e.g., the vehicle 104a) based on the expected waiting time at the charger 404. Stated another way, when the vehicle 104a arrives at the charging station 106 to get charged by using the charger 404, the processor 208 may cause the charging station 106 to set the limit on the amount of charge that may be transferred to the vehicle 104a based on the estimated waiting time at the charger 404. In further aspects, the processor 208 may cause the charger 404 to limit a charging time for the vehicle 104a based on the amount of charge described above, and a charging rate capability associated with the charger 404. For example, if the charger 404 is a fast charger (having a high charging rate capability), the processor 208 may cause the charger 404 to charge the vehicle 104a for a short time duration for a given limit of amount of charge that may be transferred to the vehicle 104a. On the other hand, if the charger 404 is not a fast charger, the processor 208 may cause the charger 404 to charge the vehicle 104a for a relatively longer time duration for the same limit of amount of charge that may be transferred to the vehicle 104a.

In some aspects, the processor 208 may cause the charging station 106 to set the limit on the amount of charge that may be transferred to the vehicle 104a, when the vehicle 104a (specifically a vehicle operator associated with the vehicle 104a) accepts having such a charging limit/constraint applied to the vehicle 104a at the charging station 106. In this case, when the vehicle 104a reaches the charging station 106 or may be travelling towards the charging station 106 to get the vehicle 104a charged (as determined via a real-time geolocation associated with the vehicle 104a obtained by the processor 208), the transceiver 206 may transmit a request to the vehicle 104a to apply a charge limit on the vehicle 104a at the charging station 106. The vehicle operator associated with the vehicle 104a may view/hear the request (e.g., via a vehicle Human-Machine Interface (HMI)), and may accept/confirm the request if the vehicle operator agrees to have the charge limit applied to the vehicle 104a at the charging station 106. In some aspects, the request may include information associated with one or more incentives that may be offered to the vehicle 104a/vehicle operator by the system 108 and/or the charging station 106, to encourage the vehicle operator to confirm/accept the request. Examples of the incentives include, but are not limited to, discount on charging price at the charging station 106, complementary services in and around the charging station 106, and/or the like. The incentives may be provided to the vehicle 104a/vehicle operator to encourage the vehicle operator to confirm/accept the request.

Responsive to the vehicle operator confirming/accepting the request, the transceiver 206 may receive a confirmation from the vehicle 104a, and may transmit the confirmation to the processor 208. The processor 208 may obtain the confirmation from the transceiver 206, and may cause the charging station 106 to limit the amount of charge that may be transferred to the vehicle 104a responsive to obtaining the confirmation. Stated another way, in some aspects, the charging station 106 may limit the amount of charge that may be transferred to the vehicle 104a only when the vehicle operator associated with the vehicle 104a accepts or confirms having a charging limit set on the vehicle 104a at the charging station 106.

In further aspects, the transceiver 206 may be configured to receive real-time vehicle inputs associated with the vehicle 104a when the vehicle 104a may be located at the charging station 106 or may be approaching the charging station 106. The transceiver 206 may receive the real-time vehicle inputs associated with the vehicle 104a directly from the vehicle 104a or from the server 202. The real-time vehicle inputs associated with the vehicle 104a may include a current vehicle SoC level, information associated with an expected future vehicle usage for a predefined future time duration, a destination location associated with a vehicle route of the vehicle 104a, and/or the like. In some aspects, the real-time vehicle inputs may include known regular schedules from fleet vehicles that may be travelling in the geographical area 102, including, but not limited to, schedules from a fleet vehicle server. The transceiver 206 may transmit the real-time vehicle inputs associated with the vehicle 104a to the processor 208.

The processor 208 may obtain the real-time vehicle inputs from the transceiver 206, and may determine an optimal range limit/SoC associated with the vehicle 104a based on the information associated with the expected future vehicle usage, the destination location and/or a distance between the charging station 106 and another charging station (that may be closest to the charging station 106) on the vehicle route. In some aspects, the processor 208 may determine the optimal range limit/SoC associated with the vehicle 104a based on the information described above such that the vehicle 104a may conveniently reach to its destination location or another charging station on the vehicle route, but at the same time, ensuring that the vehicle 104a may not get overcharged (beyond the range limit/SoC that may be necessary) at the charging station 106. For example, if the processor 208 determines that the vehicle 104a may conveniently reach its destination location if the vehicle 104a may be charged to 70% SoC level at the charging station 106, the processor 208 may determine the optimal range limit/SoC as 80% (with 10% as buffer) for the vehicle 104a. In some aspects, the processor 208 may additionally or alternatively determine the optimal range limit/SoC based on user inputs obtained from the operator/user associated with the vehicle 104a (e.g., when the vehicle operator explicitly provides an input to the system 108 indicating that the vehicle 104a should be charged to at least 80% SoC level).

Responsive to determining the optimal range limit/SoC level associated with the vehicle 104a as described above, the processor 208 may cause the charging station 106 to limit the amount of charge that may be transferred to the vehicle 104a at the charging station 106, such that the amount of charge may be based on the determined optimal range limit/SoC level and the current SoC level associated with the vehicle 104a. For example, if the current SoC level associated with the vehicle 104a may be 20% and the determined optimal SoC level may be 80%, the processor 208 may cause the charging station 106 to limit the amount of charge to 60% SoC level. Stated another way, the processor 208 may cause the charging station 106 to transfer an amount of charge to the vehicle 104a such that the vehicle's SoC level increases from 20% to 80% (and not beyond 80%). In this case, when the vehicle's SoC reaches to 80% level, the charging station 106 may automatically stop transferring charge to the vehicle 104a. Thereafter, another vehicle may get charged at the charging station 106 in the same manner as described above.

A person ordinarily skilled in the art may appreciate from the description above that the processor 208 determines the optimal SoC/range limits to maximize energy throughput of the charging station 106 to the charging vehicles (e.g., the vehicle 104a) and to minimize charge time per vehicle, while also ensuring that the vehicle users are comfortable with the “range” their vehicles may be receiving at the charging station 106. Further, the incentives/discounts offered by the system 108/charging station 106 to the users to accept/confirm the request to apply charging limit may help to get the charging station 106/charger 404 back on schedule quickly (so that it matches the reserved times by charging station customers).

In further aspects, the processor 208 may be configured to transmit/broadcast, via the transceiver 206, information associated with the charging station 106 (and other charging stations located in the geographical area 102) to the plurality of vehicles 104. The broadcasted charging information may include, but is not limited to, the location associated with the charging station 106, the expected waiting time at the charging station 106/charger 404 as a function of day/time, the real-time count of vehicles waiting to be charged at the charging station 106 as a function of day/time, information associated with the charging price at the charging station 106, and/or the like. Vehicle operators associated with the vehicles 104 may use such information to better plan charging of their respective vehicles in the geographical area 102. For example, such information may assist the vehicle operators to identify a charging station in the geographical area 102 offering charging at the least price at a given time. The vehicle operators may also use such information to better plan their errands or to help them get some extra charge in, when they may be travelling to be stopping in areas that they already were planning to spend a lot of time (movies, grocery store, hair salon, etc.). Further, if a vehicle operator may be at home during peak energy price hours, but may have plans in the evening, the vehicle operator may view which chargers may be close, not congested and cheaper, while also ensuring that the vehicle is not charged during peak hour prices.

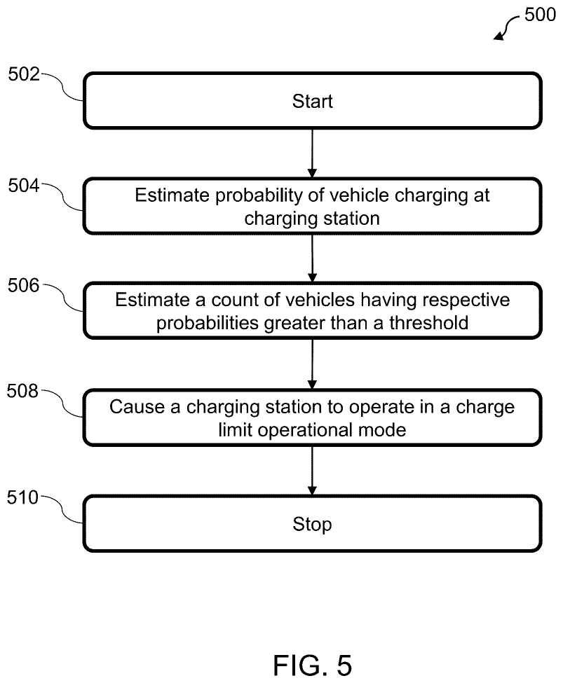

FIG. 5 depicts a flow diagram of an example charging management method 500 in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include estimating, by the processor 208, a probability of vehicle charging at the charging station 106 for each vehicle 104 based on the vehicle inputs, as described above. At step 506, the method 500 may include estimating, by the processor 208, the count of vehicles, from the plurality of vehicles 104, having respective probabilities of vehicle charging at the charging station 106 greater than the predefined probability threshold.

At step 508, the method 500 may include causing, by the processor 208, the charging station 106 to operate in the charge limit operational mode when the count of vehicles exceeds the predefined estimated count threshold. As described above, the charging station 106 may be configured to limit an amount of charge transferred to a vehicle (e.g., the vehicle 104a) when the charging station 106 operates in the charge limit operational mode.

At step 510, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A charging management system comprising:
a transceiver configured to receive vehicle inputs associated with a plurality of vehicles located in a geographical area; and
a processor communicatively coupled with the transceiver, wherein the processor is configured to:
estimate a probability of vehicle charging at a charging station located in the geographical area for vehicles of the plurality of vehicles based on the vehicle inputs;
estimate a count of vehicles, from the plurality of vehicles, having respective probabilities of vehicle charging at the charging station greater than a predefined probability threshold; and
cause the charging station to operate in a charge limit operational mode when the count of vehicles exceeds a predefined estimated count threshold, wherein the charging station is configured to limit an amount of charge transferred to a vehicle when the charging station operates in the charge limit operational mode.

2. The charging management system of claim 1, wherein the vehicle inputs comprise at least one of a state of charge (SoC) of the vehicles or information associated with historical vehicle charging events in the geographical area associated with the vehicles.

3. The charging management system of claim 1, wherein the geographical area comprises a plurality of sub-areas, and wherein the processor is further configured to:
obtain the vehicle inputs from the transceiver for a predefined time duration;
generate a heat map associated with the geographical area based on the vehicle inputs obtained for the predefined time duration, wherein the heat map indicates a count of vehicles in sub-areas of the plurality of sub-areas; and
estimate the count of vehicles having respective probabilities of vehicle charging at the charging station greater than the probability threshold based on the heat map.

4. The charging management system of claim 1, wherein the transceiver is further configured to receive real-time station inputs associated with the charging station.

5. The charging management system of claim 4, wherein the processor is further configured to:
determine a real-time count of vehicles waiting to be charged at the charging station based on the real-time station inputs, and
cause the charging station to operate in the charge limit operational mode when the real-time count of vehicles exceeds a real-time count threshold.

6. The charging management system of claim 5, wherein the amount of charge is based on the real-time count of vehicles waiting to be charged at the charging station.

7. The charging management system of claim 1, wherein the transceiver is further configured to receive real-time vehicle inputs associated with one or more vehicles getting charged at one or more chargers associated with the charging station.

8. The charging management system of claim 7, wherein the processor is further configured to:
determine at least one of an expected charge rate, an expected charge completion state of charge (SoC) level, or a current SoC level associated with vehicles of the one or more vehicles based on the real-time vehicle inputs; and
estimate an expected waiting time at the one or more chargers based on the at least one of the expected charge rate, the expected charge completion SoC level, or the current SoC level associated with vehicles of the one or more vehicles,
wherein the amount of charge is based on the expected waiting time.

9. The charging management system of claim 8, wherein the processor is further configured to cause a charger of the one or more chargers to limit a charging time for the vehicle based on the amount of charge and a charging rate capability of the charger.

10. The charging management system of claim 1, wherein the transceiver is further configured to:
transmit a request to the vehicle to apply a charge limit on the vehicle at the charging station; and
receive a confirmation from the vehicle responsive to transmitting the request.

11. The charging management system of claim 10, wherein the request comprises information associated with one or more incentives offered to the vehicle to confirm the request.

12. The charging management system of claim 10, wherein the processor is further configured to:
obtain the confirmation from the transceiver; and
cause the charging station to limit the amount of charge transferred to the vehicle responsive to obtaining the confirmation.

13. The charging management system of claim 1, wherein the transceiver is further configured to receive real-time vehicle inputs associated with the vehicle, and wherein the real-time vehicle inputs comprise one or more of a current vehicle SoC level, information associated with an expected future vehicle usage for a predefined future time duration, or a destination location associated with a vehicle route of the vehicle.

14. The charging management system of claim 13, wherein the processor is further configured to determine an optimal range limit associated with the vehicle based on at least one of the information associated with the expected future vehicle usage, the destination location or a distance between the charging station and another charging station on the vehicle route.

15. The charging management system of claim 14, wherein the processor is further configured to determine the optimal range limit based on user inputs obtained from a user associated with the vehicle.

16. The charging management system of claim 14, wherein the amount of charge is based on the current vehicle SoC level and the optimal range limit.

17. The charging management system of claim 1, wherein the transceiver is further configured to receive a location associated with the charging station, and wherein the processor is further configured to transmit at least one of the location associated with the charging station, an expected waiting time at the charging station, a real-time count of vehicles waiting to be charged at the charging station, and information associated with a charging price at the charging station to the plurality of vehicles.

18. The charging management system of claim 1, wherein the transceiver receives the vehicle inputs from at least one of the plurality of vehicles, one or more infrastructure sensors located at the geographical area, or a server.

19. A charging management method comprising:
estimating, by a processor, a probability of vehicle charging at a charging station located in a geographical area for each vehicle of a plurality of vehicles, based on vehicle inputs associated with the plurality of vehicles located in the geographical area;
estimating, by the processor, a count of vehicles, from the plurality of vehicles, having respective probabilities of vehicle charging at the charging station greater than a predefined probability threshold; and
causing, by the processor, the charging station to operate in a charge limit operational mode when the count of vehicles exceeds a predefined estimated count threshold, wherein the charging station is configured to limit an amount of charge transferred to a vehicle when the charging station operates in the charge limit operational mode.

20. A non-transitory computer-readable storage medium having instructions stored thereupon which, when executed by a processor, cause the processor to:
estimate a probability of vehicle charging at a charging station located in a geographical area for each vehicle of a plurality of vehicles, based on vehicle inputs associated with the plurality of vehicles located in the geographical area;
estimate a count of vehicles, from the plurality of vehicles, having respective probabilities of vehicle charging at the charging station greater than a predefined probability threshold; and
cause the charging station to operate in a charge limit operational mode when the count of vehicles exceeds a predefined estimated count threshold, wherein the charging station is configured to limit an amount of charge transferred to a vehicle when the charging station operates in the charge limit operational mode.
